(19) United States
(12) Patent Application Publication
(10) Pub. No.: US 2025/0131244 A1
(43) Pub. Date: Apr. 24, 2025

(54) METHOD AND DEVICE FOR IMPLEMENTING DEEP LEARNING RECOMMENDATION MODEL

(71) Applicant: SAMSUNG ELECTRONICS CO.,LTD., Suwon-si (KR)

(72) Inventors: Yangxu ZHOU, Xi'an (CN); Fei DONG, Xi'an (CN); Zhonggang CHEN, Xi'an (CN); Kun XUE, Xi'an (CN)

(73) Assignee: SAMSUNG ELECTRONICS CO.,LTD., Suwon-si (KR)

(21) Appl. No.: 18/605,227

(22) Filed: Mar. 14, 2024

(30) Foreign Application Priority Data
Oct. 20, 2023 (CN) 202311368674.2
Feb. 6, 2024 (KR) 2024-0018410

(51) Int. Cl. G06N 3/045; G06F 12/02

(52) U.S. Cl. CPC G06N 3/045; G06F 12/0246

(57) ABSTRACT

A method for implementing a deep learning recommendation model (DLRM) is provided. The method includes: querying, by a host, an embedding vector corresponding to an input sparse feature of the DLRM from a first embedding table stored in CXL memory; performing, by the host, a computation for an embedding layer using the embedding vector based on the embedding vector being found in the first embedding table; querying, by a SmartSSD, the embedding vector from a second embedding table stored in the SmartSSD and performing the computation for the embedding layer using the embedding vector found in the second embedding table, based on the embedding vector not being found in the first embedding table; and obtaining, by the host, a recommendation result based on a computation result of the embedding layer and a computation result of a bottom multilayer perceptron (MLP) for an input dense feature of the DLRM.

### CROSS-REFERENCE TO RELATED APPLICATION

This application is based on and claims priority under 35 U.S.C. § 119 to Chinese Patent Application No. 202311368674.2, filed on Oct. 20, 2023, in the China National Intellectual Property Administration, and Korean Patent Application No. 10-2024-0018410, filed on Feb. 6, 2024, in the Korean Intellectual Property Office, the disclosures of which are incorporated by reference herein in their entireties.

### BACKGROUND

### 1. Field

The present disclosure relates to data processing, and more specifically, to a method and device for implementing a deep learning recommendation model (DLRM).

### 2. Related Art

Related deep learning recommendation systems usually maintain an entire embedding layer in a host memory (e.g., a dynamic random access memory (DRAM)). However, a size of the embedding layer becomes larger and larger as a recommendation system model is used, and an infinite increase in the host memory is neither economical nor practical.

To solve the problem described above, a part of the embedding layer that is commonly used may be maintained in the host memory based on an on-demand caching strategy, and the remaining part may be stored in a disk that has a slower access speed but has larger storage capacity. However, when required data is not hit in the host memory, the required data needs to be obtained from the disk, which leads to higher long-tail latency and thus reduces quality of service.

In addition, an entire recommendation system may be offloaded as a whole or in part to a SmartSSD, but this requires a field programmable gate array (FPGA) with high computational performance. A host central processing unit (CPU) cannot be fully utilized when offloading the entire recommendation system to the SmartSSD, thereby resulting in wasted hardware resources. Severe long-tailed latency may also be caused when the embedding table becomes large, thereby reducing quality of service.

Therefore, how to further improve data processing performance of a deep learning recommendation system is an urgent issue that needs to be solved.

### SUMMARY

One or more embodiments provide a method and device for implementing a deep learning recommendation model (DLRM). The method and device for implementing the DLRM use a host and a SmartSSD to collaboratively process computations for an embedding layer to maximize use of various hardware resources and to increase inference speed.

According to an aspect of an embodiment, a method for implementing a DLRM using a host and a SmartSSD, includes: querying, by the host, an embedding vector corresponding to an input sparse feature of the DLRM from a first embedding table stored in CXL memory; performing, by the host, a computation for an embedding layer using the embedding vector based on the embedding vector being found in the first embedding table; querying, by the SmartSSD, the embedding vector from a second embedding table stored in the SmartSSD and performing the computation for the embedding layer using the embedding vector found in the second embedding table, based on the embedding vector not being found in the first embedding table; and obtaining, by the host, a recommendation result based on a computation result of the embedding layer and a computation result of a bottom multilayer perceptron (MLP) for an input dense feature of the DLRM.

According to an aspect of an embodiment, a device for implementing a DLRM, includes: a host configured to query an embedding vector corresponding to an input sparse feature of the DLRM from a first embedding table stored in CXL memory, and perform computation for an embedding layer using the embedding vector based on the embedding vector being found in the first embedding table; and a SmartSSD configured to query the embedding vector from a second embedding table stored in the SmartSSD and perform the computation for the embedding layer using the embedding vector found in the second embedding table based on the embedding vector not being found in the first embedding table. The host is further configured to obtain a recommendation result based on a computation result of the embedding layer and a computation result of a bottom multilayer perceptron (MLP) for an input dense feature of the DLRM.

According to an aspect of an embodiment, a non-transitory computer readable storage medium storing a computer program which, when executed by a processor, is configured to control the processor to perform a method for implementing a DLRM, the method including: querying, by a host, an embedding vector corresponding to an input sparse feature of the DLRM from a first embedding table stored in CXL memory; performing, by the host, a computation for an embedding layer using the embedding vector based on the embedding vector being found in the first embedding table; querying, by a SmartSSD, the embedding vector from a second embedding table stored in the SmartSSD and performing the computation for the embedding layer using the embedding vector found in the second embedding table, based on the embedding vector not being found in the first embedding table; and obtaining, by the host, a recommendation result based on a computation result of the embedding layer and a computation result of a bottom multilayer perceptron (MLP) for an input dense feature of the DLRM.

### BRIEF DESCRIPTION OF DRAWINGS

The above and other aspects will be more apparent from the following description of embodiments taken in conjunction with the accompanying drawings, in which:

FIG. 1 illustrates a schematic diagram of a deep learning recommendation model (DLRM) according to embodiments;

FIG. 2 illustrates a flowchart illustrating a method for implementing a DLRM according to embodiments;

FIG. 3 illustrates a block diagram of a structure of a device for implementing a DLRM according to embodiments; and

FIG. 4 illustrates a block diagram of a structure of a device for implementing a DLRM according to embodiments.

### DETAILED DESCRIPTION

Hereinafter, embodiments are described with reference to the accompanying drawings, in which like reference numerals are used to depict the same or similar elements, features, and structures. Embodiments described herein are example embodiments, and thus, the present disclosure is not limited thereto, and may be realized in various other forms. Each embodiment provided in the following description is not excluded from being associated with one or more features of another example or another embodiment also provided herein or not provided herein but consistent with the present disclosure. The present disclosure is not intended to be limited by the specific embodiments described herein, and it is intended that the present disclosure covers all modifications, equivalents, and/or alternatives of the present disclosure, provided they come within the scope of the appended claims and their equivalents. The terms and words used in the following description and claims are not limited to their dictionary meanings, but, are used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms include plural forms, unless the context clearly dictates otherwise. The terms “include,” “include,” and “have”, used herein, indicate disclosed functions, operations, or the existence of elements, but does not exclude other functions, operations, or elements.

Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In various embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain embodiments of the present disclosure, but are not intended to limit the scope of other embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding embodiments of the present disclosure.

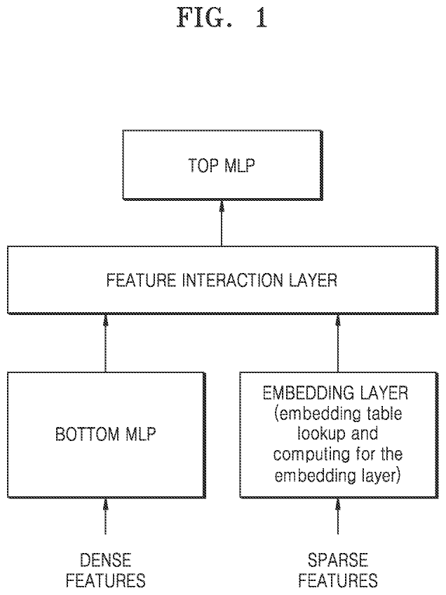

FIG. 1 illustrates a schematic diagram of implementing a deep learning recommendation model (DLRM) according to embodiments.

Referring to FIG. 1, an input of a DLRM includes a dense feature (i.e., dense input) and a sparse feature (i.e., sparse input).

The dense feature is processed by a bottom multilayer perceptron (MLP).

As understood by those skilled in the art, the bottom MLP may be a trained artificial neural network, which may include an input layer, an output layer, and a plurality of hidden layers.

Output features corresponding to the dense features may be obtained by inputting dense features into the bottom MLP and have the same dimension as features obtained by performing computations for an embedding layer described later.

For the sparse feature, an embedding vector corresponding to the sparse feature is obtained by performing embedding table lookup and computation for an embedding layer is performed based on the embedding vector that is found.

As an example, in general, a recommendation system needs to use sparse features similar to those in terms of a gender, an age, a behavior and the like, and embedding vectors corresponding to the features may be queried in an embedding table using feature identifications (IDs).

As understood by those skilled in the art, the embedding table is generally stored in a host memory and typically contributes most of the memory requirements of the DLRM and only a small portion of computation for the DLRM.

As understood by those of skill in the art, performing the computation for the embedding layer represents converting input high-dimensional sparse features to low-dimensional dense features based on the obtained embedding vectors, wherein the dimensionality of the low-dimensional dense features is the same as the dimensionality of the features output by the bottom MLP.

The embedding vectors in the embedding table are low-dimensional dense vector representations (e.g., n-dimensional vectors) of objects, which can have a large amount of information (each object can correspond to an n-dimensional vector) after training through networking and so on. The objects can be understood as e.g. a product, a user, a vocabulary, etc. The querying the embedding table means querying an n-dimensional vector corresponding to an object.

Feature interaction is performed based on an output of the bottom MLP and a computation result of the embedding layer.

As understood by those skilled in the art, performing the feature interaction based on the output of the bottom MLP and the computation result of the embedding layer indicates performing an interaction on the output of the bottom MLP and the computation result of the embedding layer.

As an example, a dot-multiplication may first be performed between the output of the bottom MLP and the computation result of the embedding layer, and then the dot-multiplication result may be contacted with the output of the bottom MLP to obtain the contacted features.

The result (e.g., the contacted feature) of the feature interaction is inputted into a top MLP to obtain a recommendation result of the DLRM.

As understood by those skilled in the art, the top layer MLP represents a trained artificial neural network, which may include an input layer, an output layer, and a plurality of hidden layers.

As an example, the contacted features may be input into the top layer MLP, and then recommendation probabilities for various recommendation options may be obtained based on the output of the top layer MLP using an activation function (e.g., a sigmoid function).

For ease of description, an embedding lookup table may be referred to as an embedding table.

According to embodiments, a hot embedding table is stored in a Compute Express Link (CXL) memory by expanding host memory (e.g., a DRAM) using the CXL memory to allow an inference process (i.e., the computation process of the DLRM) to be executed on the host side as much as possible. In addition, when an embedding vector corresponding to a sparse feature cannot be obtained in the CXL memory, the embedding vector corresponding to the sparse feature is queried from the SmartSSD and computation for the embedding layer is performed based on the embedding vector that is found in the SmartSSD, so that hardware resources are more rationally used and inference speed is increased (that is, the time spent on single complete recommendation calculation reduced).

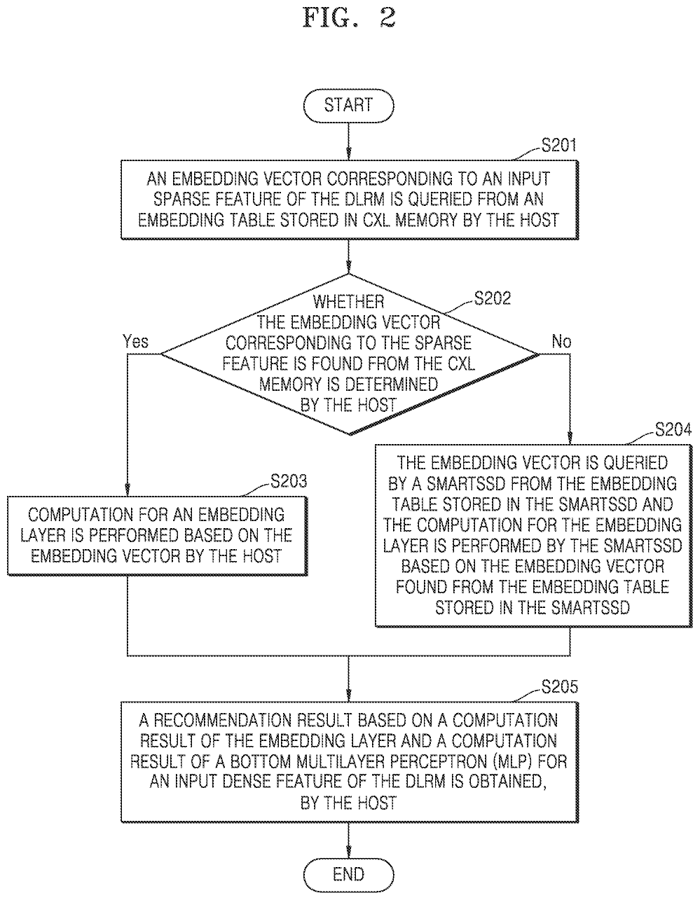

FIG. 2 illustrates a flowchart of a method for implementing a DLRM according to embodiments.

Referring to FIG. 2, at operation S201, an embedding vector corresponding to an input sparse feature of the DLRM is queried from an embedding table (which may be referred as a first embedding table) stored in CXL memory by the host.

As described above, because the CXL memory has a high access speed, it may take less time to query the embedding vector corresponding to the sparse feature from the CXL memory.

At operation S202, whether the embedding vector corresponding to the sparse feature is found from the CXL memory is determined by the host.

At operation S203, if the embedding vector is found from the embedding table stored in the CXL memory, computation for an embedding layer is performed based on the embedding vector by the host.

At operation S204, if the embedding vector is not found from the embedding table stored in said CXL memory, the embedding vector is queried by a SmartSSD from the embedding table (which may be referred as a second embedding table) stored in the SmartSSD and the computation for the embedding layer is performed by the SmartSSD based on the embedding vector found from the embedding table stored in the SmartSSD.

As understood by those skilled in the art, the first embedding table and the second embedding table may be different parts of one embedding table or different embedding tables.

As described above, the computing frequency for the embedding table is low, and offloading a portion of computation for the embedding layer to the SmartSSD may accelerate access by using its internal high-speed bandwidth, computational pressure on the host CPU is reduced, data movement is reduced, and overall performance of the recommender system is increased.

As an example, the method illustrated in FIG. 2 may further include determining, by the host, whether remaining storage space of the CXL memory is sufficient to store the content corresponding to the embedding vector in the second embedding table when the embedding vector is found from the embedding table stored in the SmartSSD. The method illustrated in FIG. 2 may further include, duplicating, by the host, the content corresponding to the embedding vector in the embedding table from the SmartSSD to the CXL memory when it is determined that the remaining storage space is sufficient to store the content corresponding to the embedding vector in the second embedding table, and deleting, by the host, partial content in the first embedding table according to a predetermined rule when it is determined that the remaining storage space is insufficient to store the content corresponding to the embedding vector in the second embedding table.

As an example, a cache replacement algorithm may be used to clear out cold data in the CXL memory that has not been used for a long time to free up storage space. For example, partial in the first embedding table that is not frequently accessed may be deleted.

As an example, the method illustrated in FIG. 2 may further include duplicating, by the host, the content corresponding to the embedding vector in the second embedding table corresponding to the embedding vector from the SmartSSD to the CXL memory after deleting the partial content in the first embedding table.

As understood by those skilled in the art, the content corresponding to the embedding vector in the second embedding table may be copied into the first embedding table.

Because the deleting operation has been performed, the CXL memory or the first embedding table will have increased available space, and therefore may have enough space to store the duplicated content.

As an example, the Smart SSD may include a NAND flash memory, a DRAM, and a field programmable gate array (FPGA). The querying of the embedding vector from the embedding table stored in the SmartSSD and the performing of the computation for the embedding layer based on the embedding vector found from the embedding table stored in the SmartSSD by the SmartSSD may include firstly querying the embedding vector from an embedding table (which may be referred as a third embedding table) stored in the DRAM by the FPGA, querying the embedding vector from an embedding table (which may be referred as a fourth embedding table) stored in the NAND flash memory by the FPGA if the embedding vector is not hit in the embedding table stored in the DRAM, and performing, by the FPGA, the computation for the embedding layer based on the embedding vector found from the DRAM or the NAND flash memory.

As understood by those skilled in the art, the third embedding table and the fourth embedding table may be different parts of one embedding table or different embedding tables.

As an example, the duplicating of the content corresponding to the embedding vector in the second embedding table from the SmartSSD to the CXL memory includes duplicating the content corresponding to the embedding vector in the third embedding table corresponding to the embedding vector from a DRAM of the SmartSSD to the CXL memory.

As an example, when the embedding vector is found by the FPGA from the embedding table stored in the NAND flash memory, the content corresponding to the embedding vector in the fourth embedding table may be sent to the DRAM of the SmartSSD, and then the content may be sent from the DRAM of the SmartSSD to the CXL memory so that the content is stored in the CXL memory or the first embedding table.

Returning to FIG. 2, at operation S205, a recommendation result based on a computation result of the embedding layer and a computation result of a bottom multilayer perceptron (MLP) for an input dense feature of the DLRM is obtained, by the host.

As an example, the obtaining of the recommendation result based on the computation result of the embedding layer and the computation result of the bottom MLP for the input dense feature includes performing, by a host, feature interaction for the computation result of the embedding layer and the computation result of the bottom MLP, and performing computation for a top MLP based on a result of the feature interaction to obtain the recommendation result.

As an example, parameters of the bottom MLP and/or the top MLP are stored in a host memory.

As understood by those skilled in the art, the parameters of the MLP may include weights and biases for each neuron of the MLP and parameters for each activation function.

As an example, the parameters corresponding to the bottom MLP, the TOP MLP, and the feature interaction layer may be read into the host memory (e.g., a DRAM) when a deep learning recommendation system is started. Because the parameters of the MLPs are small in size and are hot data that is frequently accessed, the parameters of the MLPs are read into the host memory when the recommendation system is started and remain there throughout recommendation process.

Because direct computation for the recommendation system on the host CPU is faster than that on nearby memory side, computation for the bottom MLP, feature interaction layer, and the top MLP of the recommendation system is divided for the host CPU, which may ensure a faster inference speed.

As an example, a hot embedding table is stored in the CXL memory and a cold embedding table is stored in the SmartSSD. It should be understood by those skilled in the art that the hot embedding table indicates an embedding table that is accessed frequently and the cold embedding table indicates an embedding table that is not accessed frequently.

As an example, a part of the embedding tables may be read from the SmartSSD into the CXL memory when the recommendation system is started. For example, a part of embedding tables may be read from the NAND flash memory and/or DRAM of the SmartSSD into the CXL memory.

The implementation scheme of the deep learning recommendation model according the embodiments may support a recommendation system with large-scale embedding tables, reduce the stage computation latency of the recommendation system, accelerate a speed of inference computation, and at the same time reduce transmission of a large amount of data of the embedding table between the SmartSSD and the host, which improves overall performance of the recommendation system.

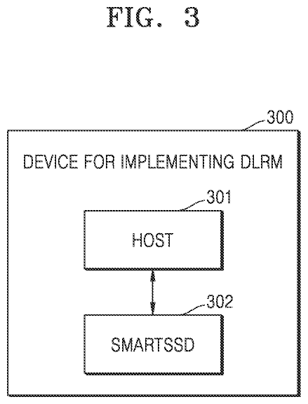

The method for implementing a DLRM according to embodiments is described above with reference to FIGS. 1 and 2, and the device for implementing a DLRM according to embodiments is described below with reference to FIG. 3.

FIG. 3 illustrates a block diagram of a structure of a device 300 for implementing a DLRM according to embodiments.

Referring to FIG. 3, the device 300 for implementing the DLRM may include a host 301 and a SmartSSD 302. It should be appreciated by those skilled in the art that the device 300 for implementing the DLRM may additionally include other components, and at least one of components included in the device 300 for implementing the DLRM may be combined or divided.

As an example, the host 301 may include a DRAM, a CXL memory, or a CPU, and the SmartSSD 302 may include a DRAM, an FPGA, or a NAND flash memory. The host 301 and the SmartSSD 302 may be connected via an interface.

As an example, the host 301 may be configured to query an embedding vector corresponding to an input sparse feature of the DLRM from an embedding table (which may be referred as a first embedding table) stored in CXL memory, and perform computation for an embedding layer based on the embedding vector if the embedding vector is found from the embedding table stored in the CXL memory.

As an example, the SmartSSD 302 may be configured to query the embedding vector from an embedding table (which may be referred as a second embedding table) stored in the SmartSSD 302 and perform the computation for the embedding layer based on the embedding vector found from the embedding table stored in the SmartSSD 302 if the embedding vector is not found from the embedding table stored in the CXL memory.

As an example, the host 301 may further be configured to obtain a recommendation result based on a computation result of the embedding layer and a computation result of a bottom multilayer perceptron (MLP) for an input dense feature of the DLRM.

As an example, the host 301 may also be configured to determine whether remaining storage space of the CXL memory is sufficient to store content corresponding to the embedding vector in the second embedding table, when the embedding vector is found from the embedding table stored in the SmartSSD 302, duplicate the content corresponding to the embedding vector in the second embedding table from the SmartSSD 302 to the CXL memory when it is determined that the remaining storage space is sufficient to store the content corresponding to the embedding vector in the second embedding table, and delete partial content in the first embedding table according to a predetermined rule, when it is determined that the remaining storage space is insufficient to store the content corresponding to the embedding vector in the second embedding table.

As an example, the host 301 may further be configured to duplicate the content corresponding to the embedding vector in the second embedding table from the content in the first embedding table.

As an example, the host 301 may be configured to perform feature interaction for the computation result of the embedding layer and the computation result of the bottom MLP, and perform computation for a top MLP based on a result of the feature interaction to obtain the recommendation result.

As an example, parameters of the bottom MLP and/or the top MLP are stored in a dynamic random access memory (DRAM) of the host 301.

As an example, a hot embedding table is stored in the CXL memory and a cold embedding table is stored in the SmartSSD 302.

As an example, the SmartSSD 302 may include a NAND flash memory, a dynamic random access memory DRAM, and an FPGA, wherein the FPGA is configured to firstly query the embedding vector from an embedding table (which may be referred as a third embedding table) stored in the DRAM, query the embedding vector from an embedding table (which may be referred as a fourth embedding table) stored in the NAND flash memory if the embedding vector is not hit in the embedding table stored in the DRAM, and perform the computation for the embedding layer based on the embedding vector found from the DRAM or the NAND flash memory.

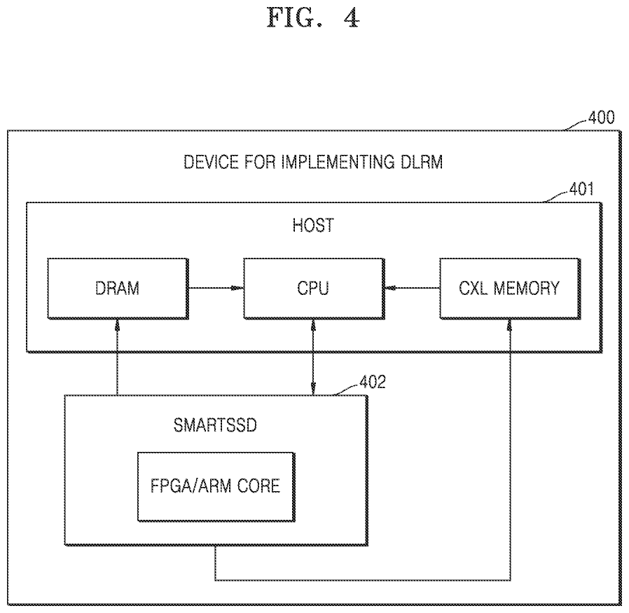

FIG. 4 illustrates a block diagram of a structure of a device for implementing a DLRM according to embodiments of the present disclosure.

Referring to FIG. 4, for an input sparse feature (i.e., a high-dimensional sparse feature) of the DLRM, an embedding vector corresponding to the input sparse feature may be queried by the host (e.g., a central processing unit (CPU) of the host) from an embedding table (e.g., a hot embedding table) in the CXL memory, and when the embedding vector is found, a computation for the embedding layer of the DLRM is performed by the host based on the found embedding vector to obtain a low-dimensional dense feature corresponding to a high-dimensional sparse feature, and a recommendation result of the DLRM is obtained by the host based on the low-dimensional dense feature and the output of the bottom MLP of the DLRM. In this case, the inference computation for the DLRM are all performed by the host.

When the embedding vector corresponding to the input sparse feature is not found in the CXL memory, the embedding vector corresponding to the input sparse feature is looked up from the embedding table stored in the SmartSSD, and when the embedding vector is found in the SmartSSD, the computation for the embedding layer is performed by the SmartSSD based on the found embedding vector, and then the computation result is sent to the host. The host obtains the recommendation result of the DLRM based on the received computation result and the output of the bottom MLP of the DLRM. In this case, the embedding layer of the DLRM is offloaded to the SmartSSD and the SmartSSD performs the computation for the embedding layer, and thus the SmartSSD can undertake partial computation of the host and can improve its own hardware utilization.

As an example, the parameters of the bottom MLP and the top MLP of the DLRM may be stored in the SmartSSD and may be read into host memory (e.g., DRAM) for use by a processor (e.g., CPU) of the host when the recommendation system is booted up, due to the fact that the parameters of the MLP are small in size and are hot data that is frequently used.

As understood by those skilled in the art, the CXL memory in FIG. 4 may be viewed as an extension of the host memory (i.e., the DRAM).

As an example, when an embedding vector is found in the SmartSSD, content corresponding to the found embedding vector in the embedding table of the SmartSSD may be copied from the SmartSSD to the CXL memory.

According to an embodiment, there may be provided a computer-readable storage medium, which may be non-transitory, storing instructions, when executed by at least one processor, causing the at least one processor to perform the method for implementing the DLRM according to embodiments. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

According to an embodiment, there may be provided a computer program product, wherein instructions in the computer program product may be executed by a processor of a computer device to implement the method for implementing the DLRM described herein.

In some embodiments, each of the components, elements, modules or units discussed above may be implemented as various numbers of hardware, software and/or firmware structures that execute respective functions described above, according to embodiments. For example, at least one of these components, elements, modules or units may include various hardware components including a digital circuit, a programmable or non-programmable logic device or array, an application specific integrated circuit (ASIC), or other circuitry using use a direct circuit structure, such as a memory, a processor, a logic circuit, a look-up table, etc., that may execute the respective functions through controls of one or more microprocessors or other control apparatuses. Also, at least one of these components, elements, modules or units may include a module, a program, or a part of code, which contains one or more executable instructions for performing specified logic functions, and executed by one or more microprocessors or other control apparatuses. Also, at least one of these components, elements, modules or units may further include or may be implemented by a processor such as a central processing unit (CPU) that performs the respective functions, a microprocessor, or the like. Functional aspects of embodiments may be implemented in algorithms that execute on one or more processors. Furthermore, the components, elements, modules or units represented by a block or processing steps may employ any number of related art techniques for electronics configuration, signal processing and/or control, data processing and the like.

While aspects of embodiments have been particularly shown and described, it will be understood that various changes in form and details may be made therein without departing from the spirit and scope of the following claims.

What is claimed is:

1. A method for implementing a deep learning recommendation model (DLRM) using a host and a SmartSSD, the method comprising:
querying, by the host, an embedding vector corresponding to an input sparse feature of the DLRM from a first embedding table stored in CXL memory;
performing, by the host, a computation for an embedding layer using the embedding vector based on the embedding vector being found in the first embedding table;
querying, by the SmartSSD, the embedding vector from a second embedding table stored in the SmartSSD and performing the computation for the embedding layer using the embedding vector found in the second embedding table, based on the embedding vector not being found in the first embedding table; and
obtaining, by the host, a recommendation result based on a computation result of the embedding layer and a computation result of a bottom multilayer perceptron (MLP) for an input dense feature of the DLRM.

2. The method for implementing the DLRM of claim 1, wherein the method further comprises:
determining, by the host, whether remaining storage space of the CXL memory is sufficient to store content corresponding to the embedding vector in the second embedding table, based on the embedding vector being found in the second embedding table;
duplicating, by the host, the content corresponding to the embedding vector in the second embedding table from the SmartSSD to the CXL memory, based on a determination that the remaining storage space is sufficient to store the content corresponding to the embedding vector in the second embedding table; and
deleting, by the host, partial content in the first embedding table according to a predetermined rule, based on a determination that the remaining storage space is insufficient to store the content corresponding to the embedding vector in the second embedding table.

3. The method for implementing the DLRM of claim 2, wherein the method further comprises:
duplicating, by the host, the content corresponding to the embedding vector in the second embedding table from the SmartSSD to the CXL memory after deleting the partial content in the first embedding table.

4. The method for implementing the DLRM of claim 3, wherein the obtaining comprises:
performing, by the host, feature interaction for the computation result of the embedding layer and the computation result of the bottom MLP, and performing computation for a top MLP based on a result of the feature interaction to obtain the recommendation result.

5. The method for implementing the DLRM of claim 4, wherein parameters of any one or any combination of the bottom MLP and the top MLP are stored in a dynamic random access memory DRAM of the host.

6. The method for implementing the DLRM of claim 1, wherein a hot embedding table is stored in the CXL memory and a cold embedding table is stored in the SmartSSD.

7. The method for implementing the DLRM of claim 1, wherein the SmartSSD comprises a NAND flash memory, a dynamic random access memory (DRAM), and a field programmable gate array (FPGA), and
wherein the querying the embedding vector from the second embedding table stored in the SmartSSD comprises:
querying the embedding vector from an embedding table stored in the DRAM by the FPGA;
querying the embedding vector from an embedding table stored in the NAND flash memory by the FPGA based on the embedding vector not being hit in the embedding table stored in the DRAM, and
wherein the performing the computation for the embedding layer using the embedding vector found in the second embedding table comprises:
performing, by the FPGA, the computation for the embedding layer based on the embedding vector found in the embedding table of the DRAM or the embedding table of the NAND flash memory.

8. A device for implementing a deep learning recommendation model (DLRM), comprising:
a host configured to query an embedding vector corresponding to an input sparse feature of the DLRM from a first embedding table stored in CXL memory, and perform computation for an embedding layer using the embedding vector based on the embedding vector being found in the first embedding table; and
a SmartSSD configured to query the embedding vector from a second embedding table stored in the SmartSSD and perform the computation for the embedding layer using the embedding vector found in the second embedding table based on the embedding vector not being found in the first embedding table,
wherein the host is further configured to obtain a recommendation result based on a computation result of the embedding layer and a computation result of a bottom multilayer perceptron (MLP) for an input dense feature of the DLRM.

9. The device for implementing the DLRM of claim 8, wherein the host is further configured to:
determine whether remaining storage space of the CXL memory is sufficient to store content corresponding to the embedding vector in the second embedding table, based on the embedding vector being found in the second embedding table;
duplicate the content corresponding to the embedding vector in the second embedding table from the SmartSSD to the CXL memory based on a determination that the remaining storage space is sufficient to store the content corresponding to the embedding vector in the second embedding table; and
delete partial content in the first embedding table according to a predetermined rule, based on a determination that the remaining storage space is insufficient to store the content corresponding to the embedding vector in the second embedding table.

10. The device for implementing the DLRM of claim 8, wherein the host is further configured to duplicate the content corresponding to the embedding vector in the second embedding table from the SmartSSD to the CXL memory after deleting partial content in the first embedding table.

11. The device for implementing the DLRM of claim 10, wherein the host is configured to perform feature interaction for the computation result of the embedding layer and the computation result of the bottom MLP, and perform computation for a top MLP based on a result of the feature interaction to obtain the recommendation result.

12. The device for implementing the DLRM of claim 11, wherein parameters of any one or any combination of the bottom MLP and the top MLP are stored in a dynamic random access memory DRAM of the host.

13. The device for implementing the DLRM of claim 8, wherein a hot embedding table is stored in the CXL memory and a cold embedding table is stored in the SmartSSD.

14. The device for implementing the DLRM of claim 8, wherein the SmartSSD comprises a NAND flash memory, a dynamic random access memory (DRAM), and a field programmable gate array (FPGA), and
wherein the FPGA is configured to:
query the embedding vector from an embedding table stored in the DRAM;
query the embedding vector from an embedding table stored in the NAND flash memory based on the embedding vector not being hit in the embedding table stored in the DRAM; and
perform the computation for the embedding layer based on the embedding vector found in the embedding table of the DRAM or the embedding table of the NAND flash memory.

15. A non-transitory computer readable storage medium storing a computer program which, when executed by a processor, is configured to control the processor to perform a method for implementing a deep learning recommendation model (DLRM), the method comprising:
querying, by a host, an embedding vector corresponding to an input sparse feature of the DLRM from a first embedding table stored in CXL memory;
performing, by the host, a computation for an embedding layer using the embedding vector based on the embedding vector being found in the first embedding table;
querying, by a SmartSSD, the embedding vector from a second embedding table stored in the SmartSSD and performing the computation for the embedding layer using the embedding vector found in the second embedding table, based on the embedding vector not being found in the first embedding table; and
obtaining, by the host, a recommendation result based on a computation result of the embedding layer and a computation result of a bottom multilayer perceptron (MLP) for an input dense feature of the DLRM.

16. The non-transitory computer readable storage medium of claim 15, wherein the method further comprises:
determining, by the host, whether remaining storage space of the CXL memory is sufficient to store content corresponding to the embedding vector in the second embedding table, based on the embedding vector being found in the second embedding table;
duplicating, by the host, the content corresponding to the embedding vector in the second embedding table from the SmartSSD to the CXL memory, based on a determination that the remaining storage space is sufficient to store the content corresponding to the embedding vector in the second embedding table; and
deleting, by the host, partial content in the first embedding table according to a predetermined rule, based on a determination that the remaining storage space is insufficient to store the content corresponding to the embedding vector in the second embedding table.

17. The non-transitory computer readable storage medium of claim 16, wherein the method further comprises:
duplicating, by the host, the content corresponding to the embedding vector in the second embedding table from the SmartSSD to the CXL memory after deleting the partial content in the first embedding table.

18. The non-transitory computer readable storage medium of claim 17, wherein the obtaining comprises:
performing, by the host, feature interaction for the computation result of the embedding layer and the computation result of the bottom MLP, and performing computation for a top MLP based on a result of the feature interaction to obtain the recommendation result.

19. The non-transitory computer readable storage medium of claim 18, wherein parameters of any one or any combination of the bottom MLP and the top MLP are stored in a dynamic random access memory DRAM of the host.

20. The non-transitory computer readable storage medium of claim 15, wherein a hot embedding table is stored in the CXL memory and a cold embedding table is stored in the SmartSSD.
